(19) United States
(12) Patent Application Publication
(10) Pub. No.: US 2026/0270472 A1
(43) Pub. Date: Sep. 10, 2026

(54) EXTRAPOLATION INTRA PREDICTION MODEL FOR CHROMA CODING

(71) Applicant: MEDIATEK INC., Hsinchu City (TW)

(72) Inventors: Chia-Ming TSAI, Hsinchu City (TW); Cheng-Yen CHUANG, Hsinchu City (TW); Hsin-Yi TSENG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/473,444

(22) PCT Filed: Oct. 25, 2024
(86) PCT No.: PCT/CN2024/127229

§ 371 Date: Oct. 7, 2025

Related U.S. Application Data
(60) Provisional application No. 63/592,930, filed on Oct. 25, 2023.

(51) Int. Cl. H04N 19/593; H04N 19/105; H04N 19/132; H04N 19/172; H04N 19/176; H04N 19/182; H04N 19/186

(52) U.S. Cl. CPC H04N 19/593; H04N 19/105; H04N 19/132; H04N 19/172; H04N 19/176; H04N 19/182; H04N 19/186

(57) ABSTRACT

A method for using extended intra prediction (EIP) or multiple source sample-based prediction to generate cross-component prediction of chroma samples is provided. A video coder receives data to be encoded or decoded as a current block of pixels of a current picture of a video. The video coder determines a model for predicting at least one target sample based on a set of one or more neighboring source samples. The at least one target sample is a chroma sample. The video coder applies the model to generate a predictor of the current block, specifically to generate predictions of chroma samples of the current block. The video coder encodes or decodes the current block by using the generated predictor.

### CROSS REFERENCE TO RELATED PATENT APPLICATION(S)

The present disclosure is part of a non-provisional application that claims the priority benefit of U.S. Provisional Patent Application No. 63/592,930, filed on 25 Oct. 2023. Content of above-listed application is herein incorporated by reference.

### TECHNICAL FIELD

The present disclosure relates generally to video coding. In particular, the present disclosure relates to methods of coding pixel blocks by extrapolation intra prediction (EIP) and cross-component prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for using extended intra prediction (EIP) or multiple source sample-based prediction to generate cross-component prediction of chroma samples. A video coder receives data to be encoded or decoded as a current block of pixels of a current picture of a video. The video coder determines a model for predicting at least one target sample based on a set of one or more neighboring source samples. The at least one target sample is a chroma sample. The video coder applies the model to generate a predictor of the current block, specifically to generate predictions of chroma samples of the current block. The video coder encodes or decodes the current block by using the generated predictor.

In some embodiments, the model is for predicting a set of more than one target samples (may be all chroma samples) based on the neighboring source samples. The set of neighboring source samples may be downsampled or non-downsampled luma samples. In some embodiments, a group of M×N samples provide P×Q target samples and the remainder as source samples. In some embodiments, the model is applied to samples in the current block and samples in a template region neighboring the current block to generate the predictor of the current block.

In some embodiments, the model is provided by a candidate selected from a plurality of candidates, namely a merge list that includes spatial adjacent, spatial non-adjacent, history-based candidates, or default candidates. In some embodiments, the model is derived by using samples from a reference area as corresponding source and target samples of a filter. In some embodiments, the model comprises filter coefficients that are derived by minimising mean-square-error (MSE) between corresponding source samples and target samples (e.g., the model may be a 7-tap convolution filter having a 5-tap plus sign shape spatial component, a nonlinear term and a bias term.)

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates some defined types of reconstructed areas.

FIG. 2 illustrates some defined types of filter shapes.

FIG. 3 shows examples of generating predictions for different positions in the current block by a diagonal order.

FIG. 4 illustrates the spatial parts of the convolution filter.

FIG. 5 illustrates a reference area for calculating the filter coefficients for convolution cross-component model (CCCM).

FIG. 6 shows four Sobel based gradient patterns for Gradient Linear Model.

FIG. 7 illustrates non-downsampled neighboring luma samples used to derive a chroma sample.

FIGS. 8A-B illustrate the corresponding luma samples and neighboring chroma samples of the current chroma sample.

FIGS. 9A-H illustrate example patterns of corresponding luma samples used to predict a chroma sample.

FIGS. 10A-B show the prediction of the current chroma as the combination of the corresponding downsampled luma samples and neighboring chroma samples.

FIGS. 11A-D show some additional patterns of the corresponding downsampled luma samples for predicting the current chroma sample.

FIG. 12 shows derivation of multiple target samples using same/shared kernel block of the multiple-source sample-based prediction.

FIG. 13 illustrates an example video encoder that may implement multiple source sample-based prediction (MSSBP).

FIG. 14 illustrates portions of the video encoder that implement cross-component MSSBP.

FIG. 15 conceptually illustrates a process that uses cross-component MSSBP to encode a pixel block.

FIG. 16 illustrates an example video decoder that may implement multiple source sample-based prediction (MSSBP).

FIG. 17 illustrates portions of the video decoder that implement cross-component MSSBP.

FIG. 18 conceptually illustrates a process that uses cross-component MSSBP to decode a pixel block.

FIG. 19 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Extrapolation Intra Prediction (EIP)

Extrapolation Intra Prediction, or EIP, is a process for generating the predictor for each sample in one block. It is therefore also called multiple source sample-based prediction (MSSBP). In some applications, EIP is restricted to the block size not greater than 32×32 and intra slice only.

For EIP, an offset value may be removed when feeding the inputs to the EIP filter. The top-left reconstructed pixel from a pre-defined neighboring area of the current block is used as the offset value for EIP prediction. The min and max value may be obtained from reconstructed pixels in the pre-defined reconstructed area of the current block.

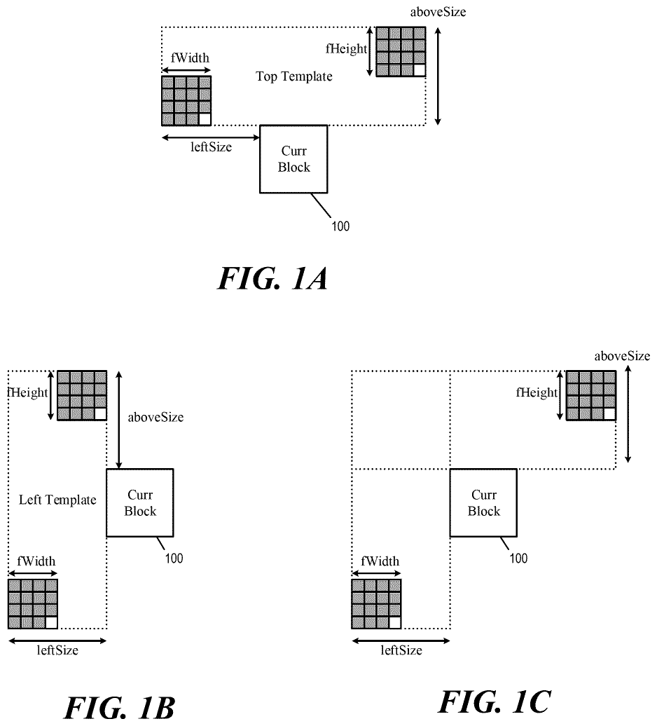

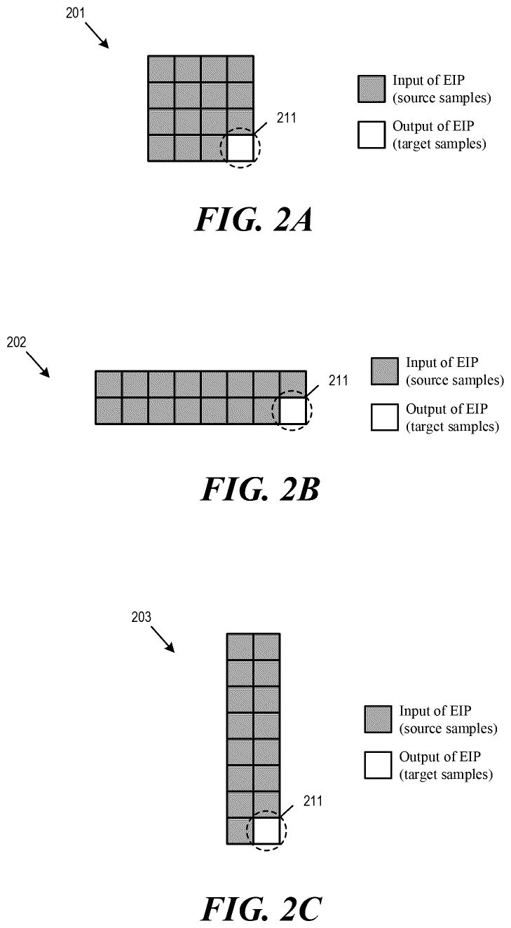

In some embodiments, there are three types of reconstructed areas and three filter shapes. FIG. 1 illustrates three defined types of reconstructed areas. FIG. 2 illustrates three defined types of filter shapes that have 15 inputs and generate one output.

When the current block is predicted by using the EIP mode, the decoder decodes the relevant syntax elements to determine the selected type of reconstructed area and the filter shape for the current block. The size of reconstructed area depends on the min (blockWidth, blockHeight) and the selected filter shape. For the example illustrated, when the current block is an 8×16 block and the 20 selected filter shape is 4×4. The aboveSize of reconstructed area is min (8, 16)+4−1=11, and the leftSize of reconstructed area is min (8, 16)+4−1=11.

The selected filter moves in the selected reconstructed area with a one-pixel step to collect input samples and output samples of EIP. The auto-correlation matrix and cross-correlation vector are constructed while removing the offset value from input samples and output samples. Then, the EIP coefficients are obtained by the same method for deriving CCCM filter coefficients as described in Section III.B below, specifically, by minimising mean-square-error (MSE) between corresponding input samples and output samples. Specifically, the filter coefficients cᵢ are calculated by minimising MSE between predicted and reconstructed chroma samples in a reference area.

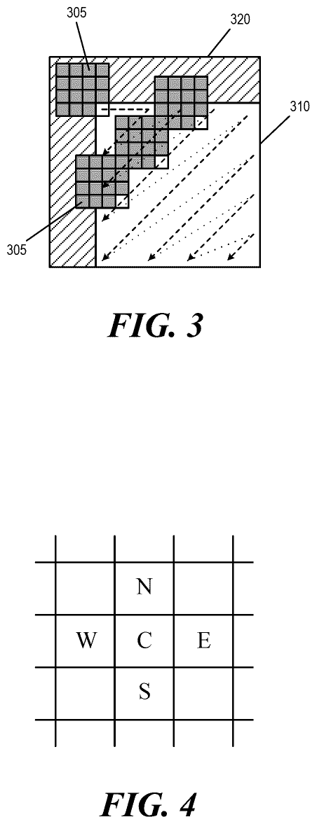

The EIP mode generates predictions for the current block from the top-left position to the bottom-right position by a diagonal prediction order, as shown in FIG. 3, which shows examples of generating predictions for different positions in the current block by a diagonal order. To reduce the prediction error, the min and max values from the neighboring reconstructed area may be applied to restrict the output range of each predicted value. The calculation for predicted samples in the test is shown as follows:

$${pred}_{( x , y )} = clip ( min , max , {\sum }_{i = 0}^{14} ( {c}_{i} \times ( {t}_{( x - xoffset , y - yoffset )} - offset ) ) + offset ) ere {pred}_{( x , y )}$$

is the predicted value at (x, y) in the current block (min, max, and offset are values described above in this section.) cᵢ is the i-th coefficient of the derived EIP filter, the index of the coefficient is from 0 to 14, t_{(x-xoffset,y-yoffset)} is reconstructed or predicted value used for the current position's prediction.
II. Intra Mode Coding with 67 Intra Prediction Modes

To capture the arbitrary edge directions presented in natural video, the number of directional intra modes is extended from 33 (as in HEVC) to 65 (as in VVC). In VVC, several conventional angular intra prediction modes may be adaptively replaced with wide-angle intra prediction modes for the non-square blocks. In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### III. Cross-Component Prediction

### A. Cross-Component Linear Model (CCLM)

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{c}(i, j) represents the predicted chroma samples in a CU and rec_{L}(i, j) represents the downsampled reconstructed luma samples of the same CU. The CCLM parameters (α and β) are derived with at most four neighbouring chroma samples and their corresponding down-sampled luma samples.

The four neighbouring luma samples at the selected positions are down-sampled and compared four times to find two larger values: x_{A}⁰ and x_{A}¹, and two smaller values: x_{B}⁰ and x_{B}¹. Their corresponding chroma sample values are denoted as y_{A}⁰, y_{A}¹, y_{B}⁰ and y_{B}¹. Then x_{A}, x_{B}, y_{A} and y_{B} are derived as:

$${X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1$$

$${Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1$$

Finally, the linear model parameters a and B are obtained according to the following equations.

$$α = \frac{{Y}_{a} - {Y}_{b}}{{X}_{a} - {X}_{b}}$$

$$β = {Y}_{b} - α \cdot {X}_{b}$$

Besides the above template and left template can be used to calculate the linear model coefficients together, they also can be used alternatively in the other 2 LM modes, called LM_A, and LM_L modes.

In LM_A mode, only the above template are used to calculate the linear model coefficients. To get more samples, the above template are extended to (W+H) samples. In LM_L mode, only left template are used to calculate the linear model coefficients. To get more samples, the left template are extended to (H+W) samples.

In LM_LA mode, left and above templates are used to calculate the linear model coefficients. To match the chroma sample locations for 4:2:0 video sequences, two types of downsampling filter are applied to luma samples to achieve 2 to 1 downsampling ratio in both horizontal and vertical directions.

### B. Convolutional Cross-Component Intra Prediction Model (CCCM)

In some embodiments, convolutional cross-component model (CCCM) is applied to predict chroma samples from reconstructed luma samples in a similar fashion as done by the current Cross-Component Linear Model (CCLM) modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

In some embodiments, CCCM uses a 7-tap convolution filter. The convolutional 7-tap filter consist of a 5-tap plus sign shape spatial component, a nonlinear term and a bias term. FIG. 4 illustrates the spatial parts of the convolution filter. As illustrated, the input to the spatial 5-tap component of the filter consists of a center (C) luma sample which is collocated with the chroma sample to be predicted and its above/north (N), below/south(S), left/west (W) and right/east (E) neighbors.

The nonlinear term P is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term B represents a scalar offset between the input and output (similarly to the offset term in CCLM) and is set to middle chroma value (512 for 10-bit content). Output of the filter is calculated as a convolution between the filter coefficients cᵢ and the input values and clipped to the range of valid chroma samples:

$$predChroma Val = {c}_{0} C + {c}_{1} N + {c}_{2} S + {c}_{3} E + {c}_{4} W + {c}_{5} P + {c}_{6} B$$

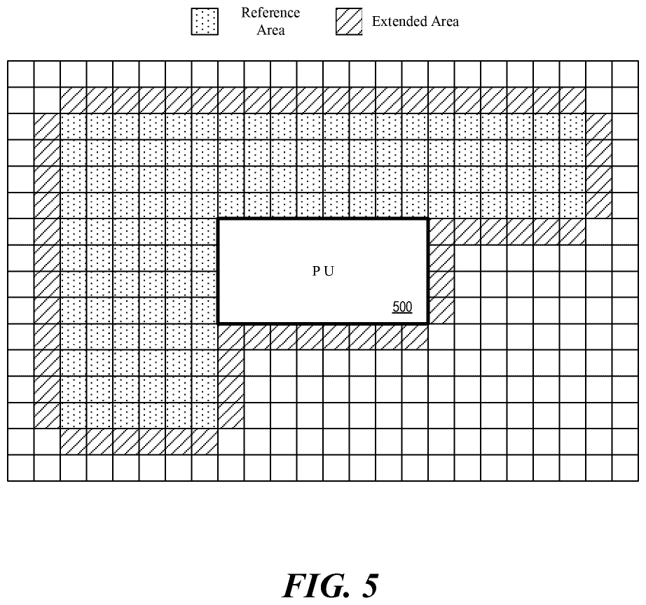

The filter coefficients cᵢ are calculated by minimising MSE between predicted and reconstructed chroma samples in a reference area. FIG. 5 illustrates a reference area for calculating the filter coefficients of the CCCM. As illustrated, the reference area 500 consists of 2 or 6 lines of chroma samples above and left of the PU. Whether to use 6 lines or 2 lines of neighbouring samples to derive the CCCM model parameters in the single model CCCM is determined by a template cost. Similarly, for the multi-model CCCM mode, the two candidates use 6 lines neighboring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

The Reference area 500 extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The calculation is similar to the calculation of the ALF filter coefficients in ECM, except LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 ≪ ( bitDepth - 1 )$$

and the chroma value is predicted using the following equation, where offsetChroma is equal to offsetCr and offsetCb for Cr and Cb components, respectively:

$$predChroma Val = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation may be replaced with multiplication (with a scale factor) and shift operation, where scale factor and number of shifts are calculated based on denominator similar to the method used in calculation of CCLM parameters.

### C. Gradient Linear Model (GLM)

For YUV 4:2:0 color format, a gradient linear model (GLM) method can be used to predict the chroma samples from luma sample gradients. Two modes are supported: a two-parameter GLM mode and a three-parameter GLM mode. Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM:

$$C = {α}_{0} \cdot G + {α}_{1} \cdot L + {α}_{2} \cdot β$$

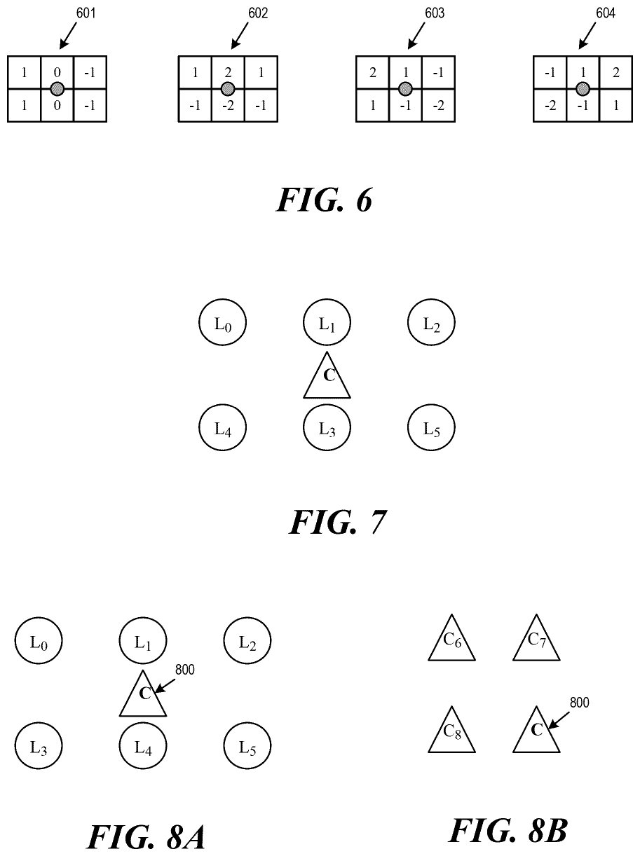

For signaling, when the CCLM mode is enabled to the current CU, one flag is signaled to indicate whether GLM is enabled for both Cb and Cr components. If GLM is enabled, another flag is signaled to indicate which of the two GLM modes is selected, and one syntax element is further signaled to select one of 4 gradient filters for the gradient calculation. FIG. 6 shows four Sobel based gradient patterns 601-604 for Gradient Linear Model (GLM).

### D. CCCM Using Non-Downsampled Luma Samples

In some embodiments, CCCM mode with 3×2 filter using non-downsampled luma samples may be used, which consists of 6-tap spatial terms, four nonlinear terms and a bias term. The 6-tap spatial terms correspond to 6 neighboring luma samples (i.e., L₀, L₁, . . . , L₅) around the chroma sample (i.e., C) to be predicted, the four non-linear terms are derived from the samples L₀, L₁, L₂, and L₃. FIG. 7 illustrates the non-downsampled neighboring luma samples used to derive a chroma sample. The chroma sample is derived according to the following:

$$C = {{\sum }_{i = 0}}^{5} \text{?} \text{?} {α}_{i} \cdot ( L {\text{?}}_{i} - offsetLuma ) + {{\sum }_{i = 6}}^{9} \text{?} {α}_{i} \cdot ( ( ( L {\text{?}}_{i - 4} \text{?} \text{?} - offsetLuma ) {\text{?}}^{2} + β ) ≫ bitDepth ) + {α}_{10} \cdot β + offsetChroma$$

Where αᵢ is the coefficient and β is the offset. Same to the existing CCCM design, up to 6 lines/columns of chroma samples above and left to the current CU are applied to derive the filter coefficients. The filter coefficients are derived based on the same LDL decomposition method used in CCCM. In some embodiments, CCCM using non-downsampled luma samples is signaled as an additional CCCM model besides the existing one, when the CCCM is selected, one single flag is signaled and used for both two chroma components to indicate whether the default CCCM model or the proposed CCCM model is applied. Additionally, SPS signaling is introduced to indicate whether the CCCM using non-downsampled luma samples is enabled.

### E. Cross-Component Prediction Merge Mode

In some embodiments, for chroma coding, the cross-component prediction (CCP) model may be provided by a candidate selected from a merge list. In some embodiments, a flag is signaled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signaled to indicate how to derive the CCP type and parameters, i.e., either from a CCP merge list or signaled/derived on-the-fly. A CCP merge candidate list is constructed from spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block. The different types of candidates are described below:

### Spatial Adjacent and Non-Adjacent Candidates

Adjacent candidates are those associated with blocks or positions that are spatially adjacent to the current block, while non-adjacent candidates are those associated with blocks or positions in the current picture but not adjacent to the current block. The positions and inclusion order of the spatial adjacent and non-adjacent candidates are the same as those defined for regular inter merge prediction candidates.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}. The offset parameter is derived according to the default scaling parameter, average neighboring reconstructed luma sample value, and average neighboring reconstructed Cb/Cr sample value.

A flag may be signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

### IV. EIP in Chroma Coding

In some embodiments, the corresponding luma samples and neighboring chroma samples are used to generate the current chroma prediction. This method may be referred to as EIP-chroma or cross-component multiple source sample-based prediction (CC-MSSBP). For example, as shown in the following figure, the prediction of the current chroma “C” is the combination of the corresponding luma samples (L₀-L₅) and the neighboring chroma samples (C₆-C₈). For example, the prediction of the current chroma “C” is:

$$C = {{\sum }_{i = 0}}^{5} {a}_{i} \times {L}_{i} + {{\sum }_{j = 6}}^{8} {a}_{j} \times {C}_{j}$$

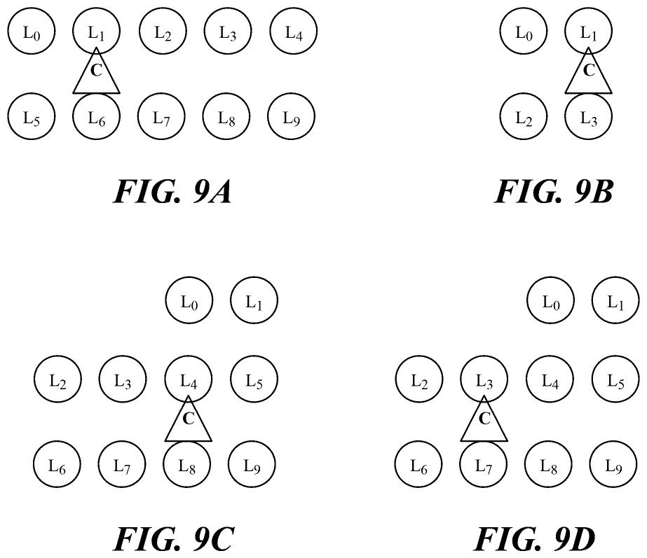

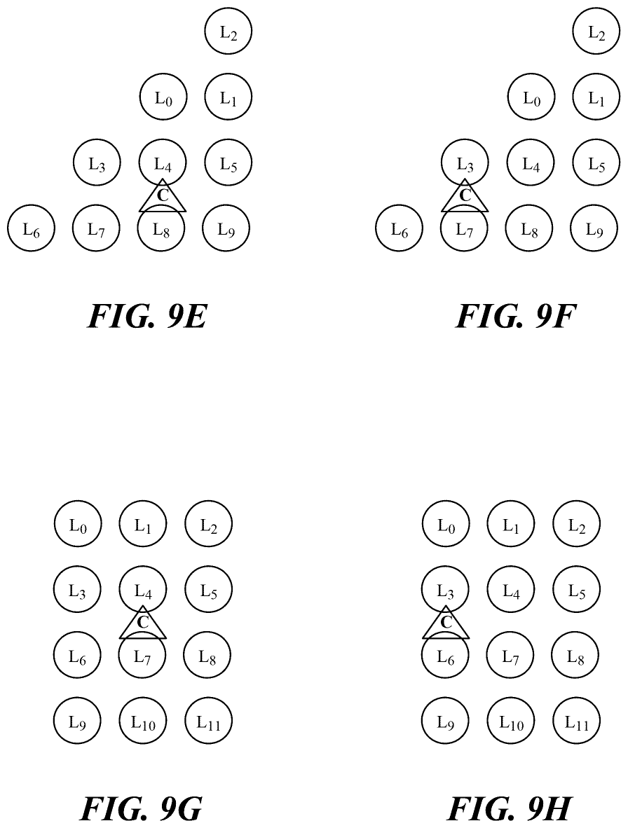

FIGS. 8A-B illustrate the corresponding luma samples (L₀-L₅) and neighboring chroma samples (C₆-C₈) of the current chroma 800. FIGS. 9A-H illustrate example patterns of corresponding luma samples (L₀-Lₙ) used to predict a chroma sample (C). In some embodiments, the corresponding downsampled luma samples (e.g., according to the current color format by applying a low-pass or high-pass downsample filtering process) and neighboring chroma samples are used to generate the current chroma prediction.

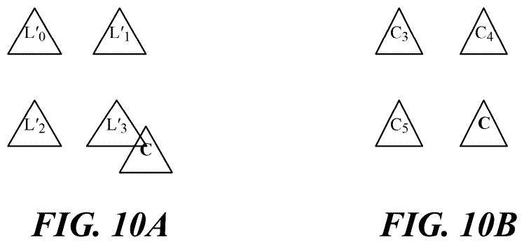

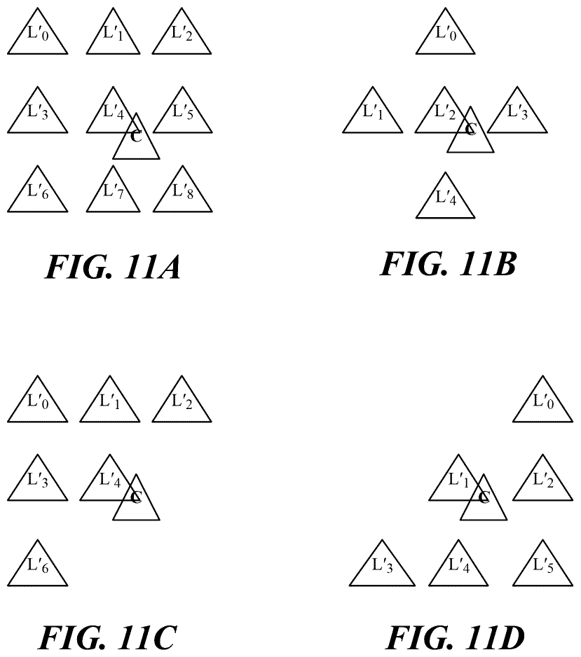

FIGS. 10A-B show the prediction of the current chroma “C” as the combination of the corresponding downsampled luma samples (L₀′-L₃′) and the neighboring chroma samples (C₃-C₅). The overlapped luma and chroma samples may be at the same phase. For some embodiments, FIGS. 11A-D show some additional patterns for the corresponding downsampled luma samples.

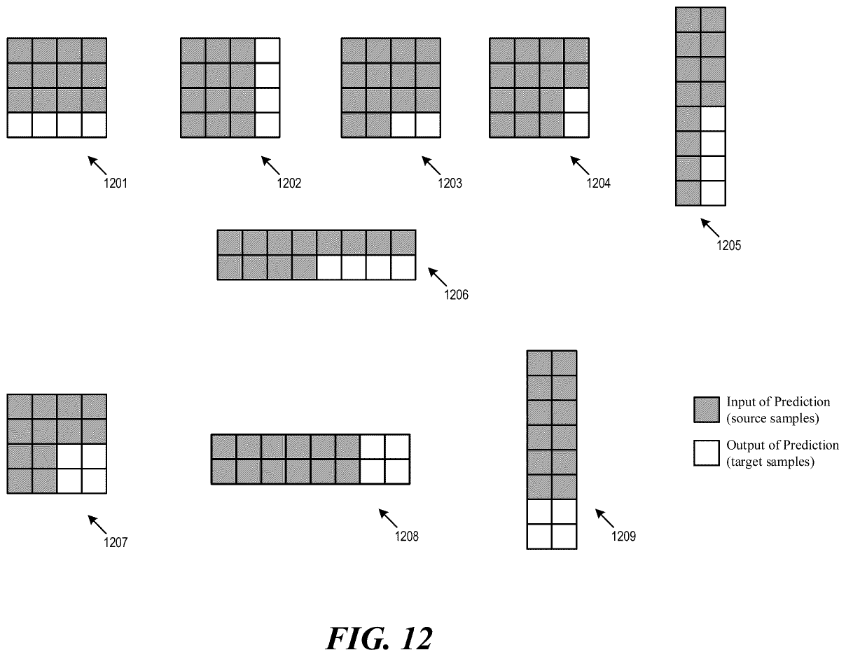

In some embodiments, more than one target samples are derived using the same/shared kernel block of the multiple-source sample-based prediction. FIG. 12 shows derivation of multiple target samples using same/shared kernel block of the multiple-source sample-based prediction. The figure shows several examples 1201-1209, each of which uses a shared kernel of source samples to derive multiple target samples. As illustrated by examples 1201-1205, the target (to-be-predicted) samples can be any M×1 or 1×N samples within a M×N block, and the source samples are the remaining Mx(N−1) or (M−1)×N samples. More generally, as illustrated by examples 1206-1209, target samples can be any P×Q samples within a M×N block (P×Q<M×N, and 1≤P≤M and 1≤Q≤N) that provide the source samples.

For still the same example, the shared source samples may be used to generate predictors for the target samples according to the following formula:

$${T}_{0} = {{\sum }_{i = 0}}^{11} {a}_{i 0} \times {S}_{i} , {T}_{1} = {{\sum }_{i = 0}}^{11} {a}_{i 1} \times {S}_{i} , {T}_{2} = {{\sum }_{i = 0}}^{11} {a}_{i 2} \times {S}_{i} , {T}_{3} = {{\sum }_{i = 0}}^{11} {a}_{i 3} \times {S}_{i}$$

In other words, multiple linear models with the same inputs but different parameters may be used to predict the multiple target samples. When solving the optimal parameters of these linear models, the auto-correlation matrices Aᵢ of all linear models are the same, and only the cross-correlation vectors bᵢ of all linear models are different. Therefore, Gaussian elimination method can be used to derive the optimal parameters of multiple models together by applying several row operations to the following combined matrix:

$$[ A {b}_{0} … {b}_{N - 1} ]$$

### V. Inheriting EIP Information

In some embodiments, all or part of the EIP information of inherited EIP model may be stored together with the inherited EIP model parameters. In some embodiments, the EIP information may include but not limited to template region selection type (e.g., EIP_T, EIP_L or EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag or model parameters.

In some embodiments, a propagation flag can be stored as part of the EIP information. This information describes if the EIP information is copied from a reference block. If a block uses EIP filter, the EIP information of the current block is derived and stored. The propagation flag of current block's EIP information is set to false. If a block does not use EIP filter, the EIP information of the current block is derived by copying the EIP information from a reference block. The propagation flag of current block's EIP information is then set to true.

In some embodiments, the EIP information may include information to indicate the source of the propagated EIP information. For example, the reference block from which the EIP information is copied may be a block in the current picture located by a block vector of the current block, a block located by a motion vector of the current block, or a collocated block of the current block.

In some embodiments, the EIP information may be added as a candidate in a merge list or history list, where the list can also include the candidates of using cross-component prediction (CCP) for chroma intra or inter prediction. For example, the EIP information can be one of candidates in intra MPM list, intra or inter CCP history list, intra or inter CCP merge list, the regular inter history list, or the regular inter merge list. For another example, the EIP candidates has the EIP information from previous coded blocks, and can be a shortcut to indicate an EIP mode (i.e., uses the current neighboring reconstruction samples to derive EIP models) rather than inheriting parameters from neighbors. For example, the default candidate of the CCP merge list may be EIP_LT, EIP_L, EIP_T.

In some embodiments, the parameters of inherited model may be further refined based on the inherited EIP information. The inherited EIP information may include how the inherited model is derived, such as the template region selection type and/or the size of template region. The refined parameters are derived based on local information. The refinement process may follow how the inherited model was derived and use the same type of template and/or the same size of template region.

In some embodiments, the parameters of inherited model may be further refined based on a pre-defined process. A pre-defined template type and a pre-defined size of template region are used for all types of inherited EIP model.

Any of the foregoing proposed methods could be applied independently or jointly. Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

### VI. Example Video Encoder

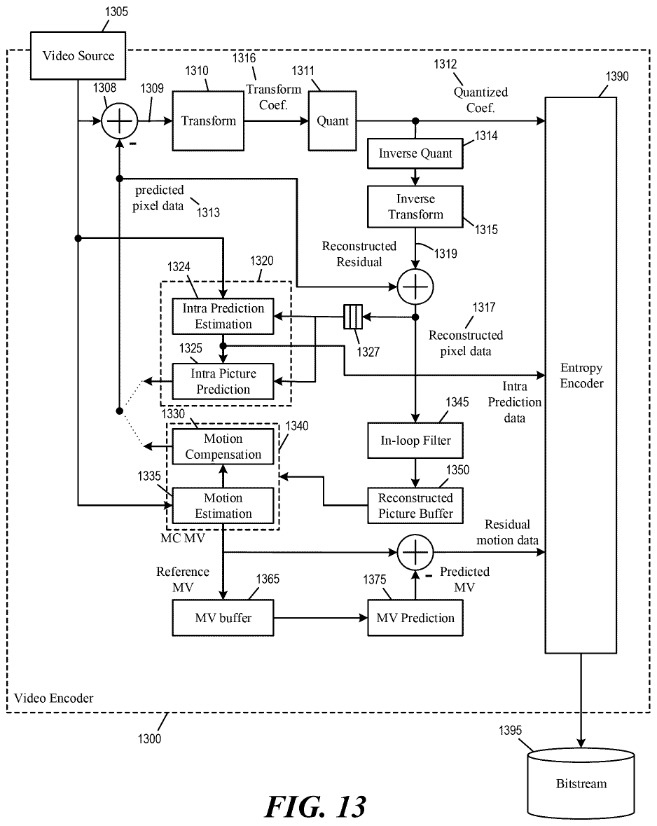

FIG. 13 illustrates an example video encoder 1300 that may implement multiple source sample-based prediction (MSSBP). As illustrated, the video encoder 1300 receives input video signal from a video source 1305 and encodes the signal into bitstream 1395. The video encoder 1300 has several components or modules for encoding the signal from the video source 1305, at least including some components selected from a transform module 1310, a quantization module 1311, an inverse quantization module 1314, an inverse transform module 1315, an intra-picture estimation module 1324, an intra-prediction module 1325, a motion compensation module 1330, a motion estimation module 1335, an in-loop filter 1345, a reconstructed picture buffer 1350, a MV buffer 1365, and a MV prediction module 1375, and an entropy encoder 1390. The motion compensation module 1330 and the motion estimation module 1335 are part of an inter-prediction module 1340. The intra-prediction module 1325 and the intra-prediction estimation module 1324 are part of a current picture prediction module 1320, which uses current picture reconstructed samples as reference samples for prediction of the current block.

In some embodiments, the modules 1310-1390 are modules of software instructions being executed by one or more processing units (e.g., a processor) of a computing device or electronic apparatus. In some embodiments, the modules 1310-1390 are modules of hardware circuits implemented by one or more integrated circuits (ICs) of an electronic apparatus. Though the modules 1310-1390 are illustrated as being separate modules, some of the modules can be combined into a single module.

The video source 1305 provides a raw video signal that presents pixel data of each video frame without compression. A subtractor 1308 computes the difference between the raw video pixel data of the video source 1305 and the predicted pixel data 1313 from the motion compensation module 1330 or intra-prediction module 1325 as prediction residual 1309. The transform module 1310 converts the difference (or the residual pixel data or residual signal 1308) into transform coefficients (e.g., by performing Discrete Cosine Transform, or DCT). The quantization module 1311 quantizes the transform coefficients into quantized data (or quantized coefficients) 1312, which is encoded into the bitstream 1395 by the entropy encoder 1390.

The inverse quantization module 1314 de-quantizes the quantized data (or quantized coefficients) 1312 to obtain transform coefficients, and the inverse transform module 1315 performs inverse transform on the transform coefficients to produce reconstructed residual 1319. The reconstructed residual 1319 is added with the predicted pixel data 1313 to produce reconstructed pixel data 1317. In some embodiments, the reconstructed pixel data 1317 is temporarily stored in a line buffer 1327 (or intra prediction buffer) for intra-picture prediction and spatial MV prediction. The reconstructed pixels are filtered by the in-loop filter 1345 and stored in the reconstructed picture buffer 1350. In some embodiments, the reconstructed picture buffer 1350 is a storage external to the video encoder 1300. In some embodiments, the reconstructed picture buffer 1350 is a storage internal to the video encoder 1300.

The intra-picture estimation module 1324 performs intra-prediction based on the reconstructed pixel data 1317 to produce intra prediction data. The intra-prediction data is provided to the entropy encoder 1390 to be encoded into bitstream 1395. The intra-prediction data is also used by the intra-prediction module 1325 to produce the predicted pixel data 1313.

The motion estimation module 1335 performs inter-prediction by producing MVs to reference pixel data of previously decoded frames stored in the reconstructed picture buffer 1350. These MVs are provided to the motion compensation module 1330 to produce predicted pixel data.

Instead of encoding the complete actual MVs in the bitstream, the video encoder 1300 uses MV prediction to generate predicted MVs, and the difference between the MVs used for motion compensation and the predicted MVs is encoded as residual motion data and stored in the bitstream 1395.

The MV prediction module 1375 generates the predicted MVs based on reference MVs that were generated for encoding previously video frames, i.e., the motion compensation MVs that were used to perform motion compensation. The MV prediction module 1375 retrieves reference MVs from previous video frames from the MV buffer 1365. The video encoder 1300 stores the MVs generated for the current video frame in the MV buffer 1365 as reference MVs for generating predicted MVs.

The MV prediction module 1375 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1395 by the entropy encoder 1390.

The entropy encoder 1390 encodes various parameters and data into the bitstream 1395 by using entropy-coding techniques such as context-adaptive binary arithmetic coding (CABAC) or Huffman encoding. The entropy encoder 1390 encodes various header elements, flags, along with the quantized transform coefficients 1312, and the residual motion data as syntax elements into the bitstream 1395. The bitstream 1395 is in turn stored in a storage device or transmitted to a decoder over a communications medium such as a network.

The in-loop filter 1345 performs filtering or smoothing operations on the reconstructed pixel data 1317 to reduce the artifacts of coding, particularly at boundaries of pixel blocks. In some embodiments, the filtering or smoothing operations performed by the in-loop filter 1345 include deblock filter (DBF), sample adaptive offset (SAO), and/or adaptive loop filter (ALF). In some embodiments, luma mapping chroma scaling (LMCS) is performed before the loop filters.

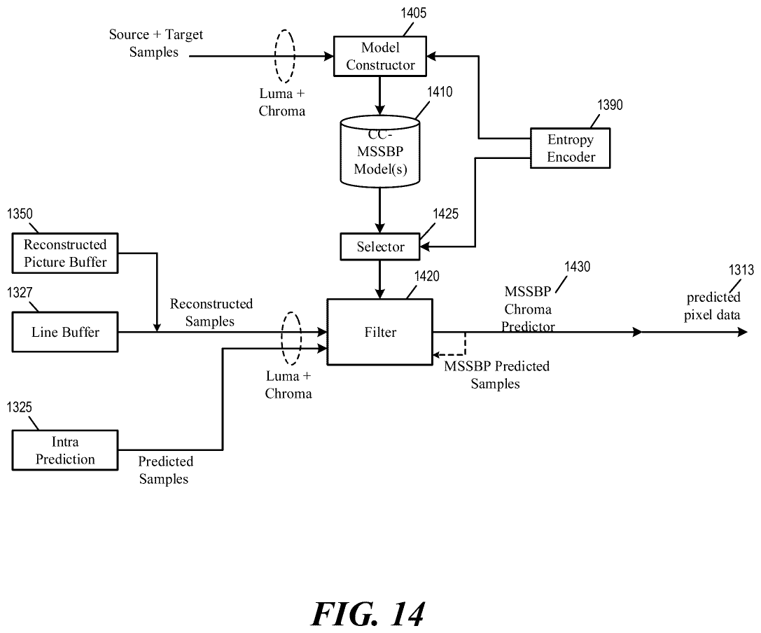

FIG. 14 illustrates portions of the video encoder 1300 that implement cross-component MSSBP. A cross-component MSSBP model constructor 1405 may retrieve source and target samples for constructing a CC-MSSBP model. Some examples of relative positions of corresponding source and target samples are described by reference to FIG. 12 above. The target samples are chroma samples. The source samples may include luma and/or chroma samples. The luma samples may be downsampled or non-downsampled. Some examples of relative positions of corresponding source luma/chroma samples and target chroma samples are described by reference to FIGS. 7-11. The source samples may be reconstructed samples (from line buffer 1327 and/or from the reconstructed picture buffer 1350), and may include luma and/or chroma samples. The source samples may be in template regions that are defined by a selected template region type, e.g., EIP_T, EIP_L, EIP_LT.

The retrieved template samples may be used to derive one or more cross-component MSSBP model by regression according to a selected filter kernel shape. Each MSSBP model is a filter that includes a set of coefficients for a set of filter taps. Example filter kernel shapes are described in Section III above. In some embodiments, the entropy encoder 1390 may specify the type or shape of the filter that is to be derived.

In some embodiments, previously derived cross-component MSSBP models are stored in a storage 1410 and may be retrieved and used for the current block. In some embodiments, a cross-component MSSBP model may be provided by a candidate that is selected from a merge list of candidates. The merge list of candidates may include spatial adjacent, spatial non-adjacent, history-based, and/or default candidates. A selector 1425 may select one of the merge candidates and retrieve the corresponding CC-MSSBP model to be used for the current block. The selection of the merge candidate for CC-MSSBP may be provided to the entropy encoder 1390 to be signaled in the bitstream 1395.

A filter 1420 applies the selected CC-MSSBP model to generate a chroma prediction 1430 for each target position in the current block, as described in Section IV above. The filter 1420 may use the target position's neighboring reconstructed samples (provided by reconstructed picture buffer 1350 or line buffer 1327,) MSSBP predicted samples (provided by the MSSBP predictor 1425), or predicted samples (provided by the intra prediction module 1325) as filter input, at source sample positions specified by the selected filter shape. The filter may traverse the current block to generate the chroma samples of the predictor according to a diagonal pattern as described by reference to FIG. 3 above. The predictions for the different target positions of the current block are provided as the MSSBP predictor 1430 and used as the predicted pixel data 1313.

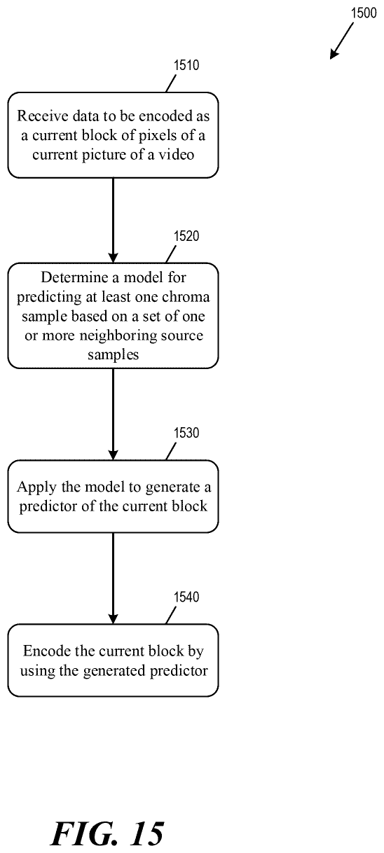

FIG. 15 conceptually illustrates a process 1500 that uses cross-component MSSBP to encode a pixel block. In some embodiments, one or more processing units (e.g., a processor) of a computing device implementing the encoder 1300 performs the process 1500 by executing instructions stored in a computer readable medium. In some embodiments, an electronic apparatus implementing the encoder 1300 performs the process 1500.

The encoder receives (at block 1510) data to be encoded as a current block of pixels in a current picture. The encoder determines (at block 1520) a model for predicting at least one target sample based on a set of one or more neighboring source samples. The at least one target sample is a chroma sample. In some embodiments, the model is for predicting a set of more than one target samples (may be all chroma samples) based on the neighboring source samples. The set of neighboring source samples may be downsampled or non-downsampled luma samples. In some embodiments, a group of M×N samples provide P×Q target samples and the remainder as source samples.

The encoder applies (at block 1530) the model to generate a predictor of the current block, specifically, specifically to generate predictions of chroma samples of the current block. In some embodiments, the model is applied to samples in the current block and samples in a template region neighboring the current block to generate the predictor of the current block.

In some embodiments, the model is provided by a candidate selected from a plurality of candidates, namely a merge list that includes spatial adjacent, spatial non-adjacent, history-based candidates, or default candidates. In some embodiments, the model is derived by using samples from a reference area as corresponding source and target samples of a filter. In some embodiments, the model comprises filter coefficients that are derived by minimising mean-square-error (MSE) between corresponding source samples and target samples (e.g., the model may be a 7-tap convolution filter having a 5-tap plus sign shape spatial component, a nonlinear term and a bias term.)

The encoder encodes (at block 1540) the current block by using the generated predictor to generate a prediction block and to produce prediction residuals.

### VII. Example Video Decoder

In some embodiments, an encoder may signal (or generate) one or more syntax element in a bitstream, such that a decoder may parse said one or more syntax element from the bitstream.

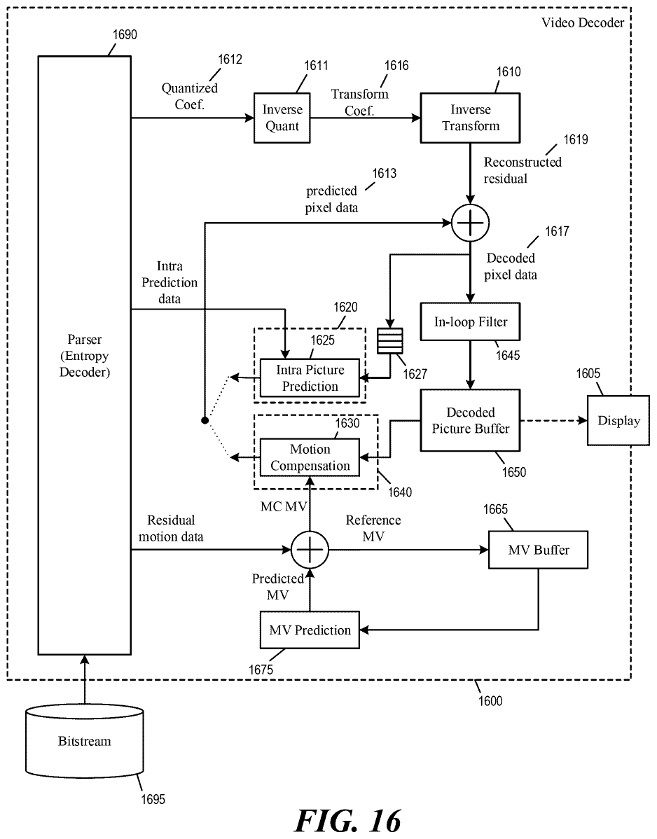

FIG. 16 illustrates an example video decoder 1600 that may implement multiple source sample-based prediction (MSSBP). As illustrated, the video decoder 1600 is an image-decoding or video-decoding circuit that receives a bitstream 1695 and decodes the content of the bitstream into pixel data of video frames for display. The video decoder 1600 has several components or modules for decoding the bitstream 1695, including some components selected from an inverse quantization module 1611, an inverse transform module 1610, an intra-prediction module 1625, a motion compensation module 1630, an in-loop filter 1645, a decoded picture buffer 1650, a MV buffer 1665, a MV prediction module 1675, and a parser 1690. The motion compensation module 1630 is part of an inter-prediction module 1640. The intra-prediction module 1625 is part of a current picture prediction module 1620, which uses current picture reconstructed samples as reference samples for prediction of the current block.

In some embodiments, the modules 1610-1690 are modules of software instructions being executed by one or more processing units (e.g., a processor) of a computing device. In some embodiments, the modules 1610-1690 are modules of hardware circuits implemented by one or more ICs of an electronic apparatus. Though the modules 1610-1690 are illustrated as being separate modules, some of the modules can be combined into a single module.

The parser 1690 (or entropy decoder) receives the bitstream 1695 and performs initial parsing according to the syntax defined by a video-coding or image-coding standard. The parsed syntax element includes various header elements, flags, as well as quantized data (or quantized coefficients) 1612. The parser 1690 parses out the various syntax elements by using entropy-coding techniques such as context-adaptive binary arithmetic coding (CABAC) or Huffman encoding.

The inverse quantization module 1611 de-quantizes the quantized data (or quantized coefficients) 1612 to obtain transform coefficients, and the inverse transform module 1610 performs inverse transform on the transform coefficients 1616 to produce reconstructed residual signal 1619. The reconstructed residual signal 1619 is added with predicted pixel data 1613 from the intra-prediction module 1625 or the motion compensation module 1630 to produce decoded pixel data 1617. The decoded pixels data are filtered by the in-loop filter 1645 and stored in the decoded picture buffer 1650. In some embodiments, the decoded picture buffer 1650 is a storage external to the video decoder 1600. In some embodiments, the decoded picture buffer 1650 is a storage internal to the video decoder 1600.

The intra-prediction module 1625 receives intra-prediction data from bitstream 1695 and according to which, produces the predicted pixel data 1613 from the decoded pixel data 1617 stored in the decoded picture buffer 1650. In some embodiments, the decoded pixel data 1617 is also stored in a line buffer 1627 (or intra prediction buffer) for intra-picture prediction and spatial MV prediction.

In some embodiments, the content of the decoded picture buffer 1650 is used for display. A display device 1605 either retrieves the content of the decoded picture buffer 1650 for display directly, or retrieves the content of the decoded picture buffer to a display buffer. In some embodiments, the display device receives pixel values from the decoded picture buffer 1650 through a pixel transport.

The motion compensation module 1630 produces predicted pixel data 1613 from the decoded pixel data 1617 stored in the decoded picture buffer 1650 according to motion compensation MVs (MC MVs). These motion compensation MVs are decoded by adding the residual motion data received from the bitstream 1695 with predicted MVs received from the MV prediction module 1675.

The MV prediction module 1675 generates the predicted MVs based on reference MVs that were generated for decoding previous video frames, e.g., the motion compensation MVs that were used to perform motion compensation. The MV prediction module 1675 retrieves the reference MVs of previous video frames from the MV buffer 1665. The video decoder 1600 stores the motion compensation MVs generated for decoding the current video frame in the MV buffer 1665 as reference MVs for producing predicted MVs.

The in-loop filter 1645 performs filtering or smoothing operations on the decoded pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF). In some embodiments, luma mapping chroma scaling (LMCS) is performed before the loop filters.

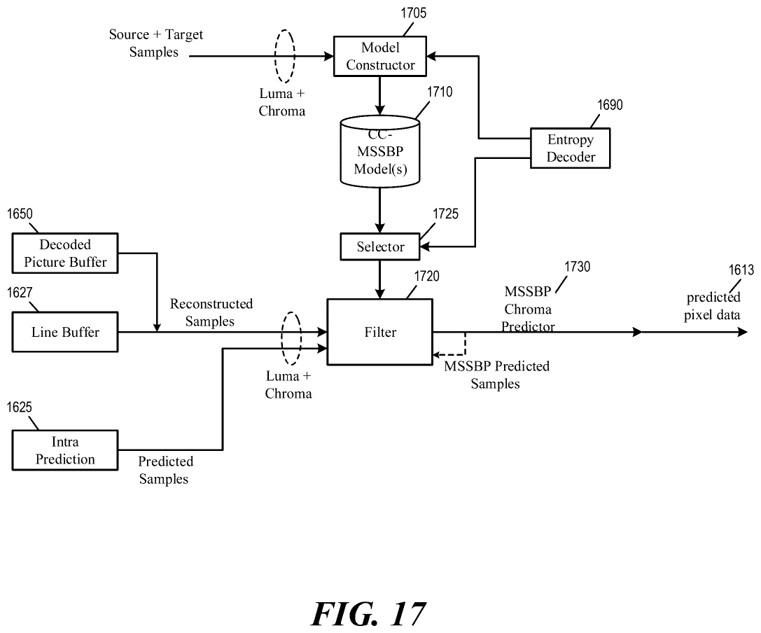

FIG. 17 illustrates portions of the video decoder 1600 that implement cross-component MSSBP. A cross-component MSSBP model constructor 1705 may retrieve source and target samples for constructing a CC-MSSBP model. Some examples of relative positions of corresponding source and target samples are described by reference to FIG. 12 above. The target samples are chroma samples. The source samples may include luma and/or chroma samples. The luma samples may be downsampled or non-downsampled. Some examples of relative positions of corresponding source luma/chroma samples and target chroma samples are described by reference to FIGS. 7-11. The source samples may be reconstructed samples (from line buffer 1627 and/or from the reconstructed picture buffer 1650), and may include luma and/or chroma samples. The source samples may be in template regions that are defined by a selected template region type, e.g., EIP_T, EIP_L, EIP_LT.

The retrieved template samples may be used to derive one or more cross-component MSSBP model by regression according to a selected filter kernel shape. Each MSSBP model is a filter that includes a set of coefficients for a set of filter taps. Example filter kernel shapes are described in Section III above. In some embodiments, the entropy decoder 1690 may specify the type or shape of the filter that is to be derived.

In some embodiments, previously derived cross-component MSSBP models are stored in a storage 1710 and may be retrieved and used for the current block. In some embodiments, a cross-component MSSBP model may be provided by a candidate that is selected from a merge list of candidates. The merge list of candidates may include spatial adjacent, spatial non-adjacent, history-based, and/or default candidates. A selector 1725 may select one of the merge candidates and retrieve the corresponding CC-MSSBP model to be used for the current block. The selection of the merge candidate for CC-MSSBP may be provided by the entropy decoder 1690 by parsing the bitstream 1695 for related syntax elements.

A filter 1720 applies the selected CC-MSSBP model to generate a chroma prediction 1730 for each target position in the current block, as described in Section IV above. The filter 1720 may use the target position's neighboring reconstructed samples (provided by reconstructed picture buffer 1650 or line buffer 1627,) MSSBP predicted samples (provided by the MSSBP predictor 1725), or predicted samples (provided by the intra prediction module 1625) as filter input, at source sample positions specified by the selected filter shape. The filter may traverse the current block to generate the chroma samples of the predictor according to a diagonal pattern as described by reference to FIG. 3 above. The predictions for the different target positions of the current block are provided as the MSSBP predictor 1730 and used as the predicted pixel data 1613.

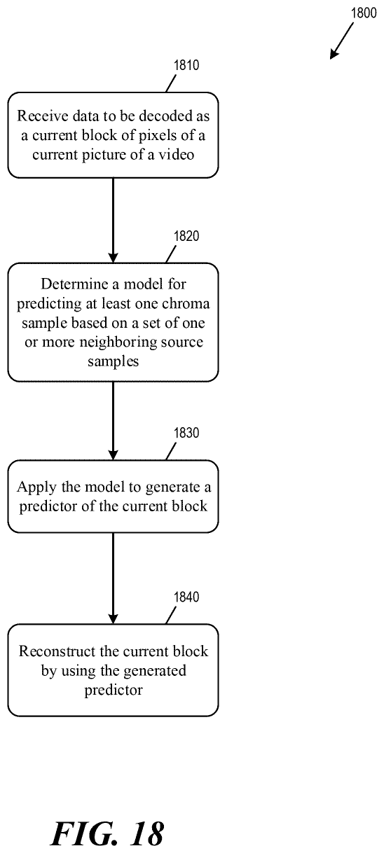

FIG. 18 conceptually illustrates a process 1800 that uses cross-component MSSBP to decode a pixel block. In some embodiments, one or more processing units (e.g., a processor) of a computing device implementing the decoder 1600 performs the process 1800 by executing instructions stored in a computer readable medium. In some embodiments, an electronic apparatus implementing the decoder 1600 performs the process 1800.

The decoder receives (at block 1810) data to be decoded as a current block of pixels in a current picture. The decoder determines (at block 1820) a model for predicting at least one target sample based on a set of one or more neighboring source samples. The at least one target sample is a chroma sample. In some embodiments, the model is for predicting a set of more than one target samples (may be all chroma samples) based on the neighboring source samples. The set of neighboring source samples may be downsampled or non-downsampled luma samples. In some embodiments, a group of M×N samples provide P×Q target samples and the remainder as source samples.

The decoder applies (at block 1830) the model to generate a predictor of the current block, specifically, specifically to generate predictions of chroma samples of the current block. In some embodiments, the model is applied to samples in the current block and samples in a template region neighboring the current block to generate the predictor of the current block.

In some embodiments, the model is provided by a candidate selected from a plurality of candidates, namely a merge list that includes spatial adjacent, spatial non-adjacent, history-based candidates, or default candidates. In some embodiments, the model is derived by using samples from a reference area as corresponding source and target samples of a filter. In some embodiments, the model comprises filter coefficients that are derived by minimising mean-square-error (MSE) between corresponding source samples and target samples (e.g., the model may be a 7-tap convolution filter having a 5-tap plus sign shape spatial component, a nonlinear term and a bias term.)

The decoder reconstructs (at block 1840) the current block by using the generated predictor to generate a prediction block to be combined with prediction residuals. The decoder may then provide the reconstructed current block for display as part of the reconstructed current picture.

### VIII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

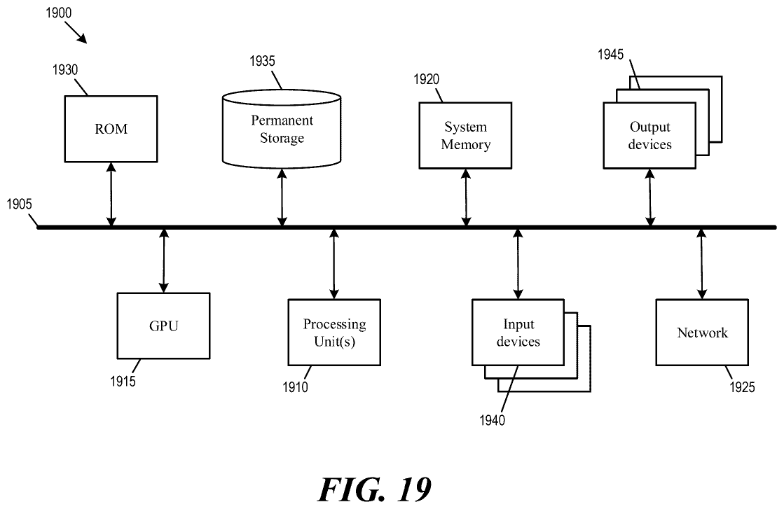

FIG. 19 conceptually illustrates an electronic system 1900 with which some embodiments of the present disclosure are implemented. The electronic system 1900 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1900 includes a bus 1905, processing unit(s) 1910, a graphics-processing unit (GPU) 1915, a system memory 1920, a network 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the GPU 1915, the read-only memory 1930, the system memory 1920, and the permanent storage device 1935.

From these various memory units, the processing unit(s) 1910 retrieves instructions to execute and data to process in order to execute the processes of the present disclosure. The processing unit(s) may be a single processor or a multi-core processor in different embodiments. Some instructions are passed to and executed by the GPU 1915. The GPU 1915 can offload various computations or complement the image processing provided by the processing unit(s) 1910.

The read-only-memory (ROM) 1930 stores static data and instructions that are used by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the present disclosure use a mass-storage device (such as a magnetic or optical disk and its corresponding disk drive) as the permanent storage device 1935.

Other embodiments use a removable storage device (such as a floppy disk, flash memory device, etc., and its corresponding disk drive) as the permanent storage device. Like the permanent storage device 1935, the system memory 1920 is a read-and-write memory device. However, unlike storage device 1935, the system memory 1920 is a volatile read-and-write memory, such a random access memory. The system memory 1920 stores some of the instructions and data that the processor uses at runtime. In some embodiments, processes in accordance with the present disclosure are stored in the system memory 1920, the permanent storage device 1935, and/or the read-only memory 1930. For example, the various memory units include instructions for processing multimedia clips in accordance with some embodiments. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1925 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 15 and FIG. 18) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
determining a model for predicting a set of more than one target samples based on a set of one or more neighboring source samples;
applying the model to generate a predictor comprising predictions of chroma samples of the current block; and
encoding or decoding the current block by using the generated predictor.

2. The video coding method of claim 1, wherein the set of neighboring source samples comprise downsampled luma samples.

3. The video coding method of claim 1, wherein the set of neighboring source samples comprise non-downsampled luma samples.

4. The video coding method of claim 1, wherein the model is applied to samples in the current block and samples in a template region neighboring the current block to generate the predictor of the current block.

5. The video coding method of claim 1, wherein the model comprises filter coefficients that are derived by minimising mean-square-error (MSE) between corresponding source samples and target samples.

6. The video coding method of claim 1, wherein the model is provided by a candidate selected from a plurality of candidates.

7. The video coding method of claim 1, wherein the model is derived by using samples from a reference area as corresponding source and target samples of a filter.

8. The video coding method of claim 1, wherein a group of M×N samples provide P×Q target samples and remainder as source samples.

9. An electronic apparatus comprising:
a video coder circuit configured to perform operations comprising:
receiving data to be encoded or decoded as a current block of pixels of a current picture of a video;
determining a model for predicting a set of more than one target samples based on a set of one or more neighboring source samples;
applying the model to generate a predictor comprising predictions of chroma samples of the current block; and
encoding or decoding the current block by using the generated predictor.

10. A video decoding method comprising:
receiving data to be decoded as a current block of pixels of a current picture of a video;
determining a model for predicting a set of more than one target samples based on a set of one or more neighboring source samples;
applying the model to generate a predictor comprising predictions of chroma samples of the current block; and
reconstructing the current block by using the generated predictor.

11. A video encoding method comprising:
receiving data to be encoded as a current block of pixels of a current picture of a video;
determining a model for predicting a set of more than one target samples based on a set of one or more neighboring source samples;
applying the model to generate a predictor comprising predictions of chroma samples of the current block; and
encoding the current block by using the generated predictor.
